(19) United States
(12) Patent Application Publication
(10) Pub. No.: US 2014/0177451 A1
(43) Pub. Date: Jun. 26, 2014

(54) SYSTEMS AND METHODS FOR MONITORING THE SETUP OF AN IP TELEPHONY COMMUNICATION

(71) Applicant: VONAGE NETWORK, LLC, Holmdel, NJ (US)

(72) Inventors: Casem MADJ, Holmdel, NJ (US); Stephen VAN SADERS, Manalapan, NJ (US); Andrew BUCKO, Old Bridge, NJ (US); Kenneth VIAUD, Somerset, NJ (US)

(21) Appl. No.: 14/137,325

(22) Filed: Dec. 20, 2013

Related U.S. Application Data
(60) Provisional application No. 61/740,054, filed on Dec. 20, 2012.

(51) Int. Cl. H04M 7/00

(52) U.S. Cl. CPC H04M 7/0084
USPC 370/241

(57) ABSTRACT

When an IP telephony system is attempting to setup a telephony communication between a calling party and a called party, the system monitors to determine if any audio or video is played to the calling party as early media. If so, the detected early media may be analyzed to determine one or more characteristics of the early media. The analysis may determine if early media is designed to cause the calling party to prematurely terminate the call setup attempt.

This application claims the priority to the filing date of U.S. Provisional Application No. 61/740,054, which was filed Dec. 20, 2012, the contents of which are hereby incorporated by reference.

### BACKGROUND OF THE INVENTION

The invention is related to Internet Protocol (IP) telephony systems. More specifically, the invention is related to systems and methods for monitoring the setup of an IP telephony communication to determine if a third party may be interfering with normal setup procedures.

When an IP telephony system receives a request from a calling party to setup a telephony communication to a called party, the request is typically received by an inbound proxy server (or an originating gateway). The inbound proxy server consults a routing engine to determine the identity of one or more outbound proxy servers or destination gateways that are capable of completing the telephony communication to the called party. The inbound proxy server then sends setup signaling to the outbound proxy server requesting that the telephony communication be established between the calling and called parties.

If everything operates properly, the outbound proxy server contacts the called party's telephony device and helps to establish the telephony communication between the calling and called party. However, setup of the telephony communication may fail for multiple different reasons. For example, if the called party does not choose to receive the telephony communication, the setup attempt will fail. If the outbound proxy server or destination gateway is unable to reach the called party's telephony device, the setup attempt will fail. Further, communication problems between the inbound proxy server and the outbound proxy server could cause the setup attempt to fail.

Moreover, the outbound proxy server or destination gateway may be relying upon a third party system, such as a publically switched telephone network (PSTN) or a cellular telephony system, to connect to the called party's telephony device. If the third party system has problems reaching the called party's telephony device, the setup attempt will also fail.

In most instances, the entity operating the outbound proxy server or destination gateway desires to make a valid attempt to reach the called party's telephony device, because the entity will get paid to complete the telephony communication. However, in some circumstances, the entity operating the outbound proxy server or destination gateway may find it desirable to avoid setting up the telephony communication. For example, the entity may find that it will not be profitable to complete the telephony communication. Also, the entity operating the outbound proxy server or destination gateway may be experiencing technical problems which make it difficult or impossible to complete the telephony communication.

In those instances where the entity operating the outbound proxy server or destination gateway does not want to complete the telephony communication, the entity may not wish for the IP telephony system operating the inbound proxy server to know that the entity is attempting to avoid setting up the telephony communication. Likewise, if the entity simply cannot setup the telephony communication, the entity also may not wish for the IP telephony system operating the inbound proxy server to know this fact. Typically, the entity will have entered into a contractual agreement with the IP telephony system, and deliberately declining a call setup request, or failure to provide service, may violate the terms of the agreement.

It is possible for the entity operating the outbound proxy server or destination gateway to play audio to the calling party while the setup procedures are being accomplished. This audio is typically called “early media.” An example of early media is the playing of a ring tone to the calling party while the called party's telephony device is ringing. Other examples of early media are the playing of a busy signal if the called party is already engaged in a telephony communication, or the playing of an audio message indicating that the call cannot be completed as dialed. The early media is played before a telephony communication is actually established between the calling party's telephony device and the called party's telephony device.

Some entities operating outbound proxy servers or destination gateways that wish to avoid setting up a telephony communication, or that cannot setup the telephony communication, will play early media to the calling party that is designed to cause the calling party to terminate the setup attempt. If the calling party simply hangs up, the call setup attempt will fail, but it will not be recorded as the fault of the entity operating the outbound proxy server or destination gateway. This prevents the entity from getting into trouble for violating the terms of an agreement with the IP telephony system which is requesting that the telephony communication be established.

In some instances, the entity operating the outbound proxy server or destination gateway will cause early media in the form of a busy signal to be played to the calling party, even through the called party is not conducting another telephony communication. Naturally, the calling party will terminate the call setup attempt, thinking that the calling party is already conducting another telephony communication. In other instances, various audio messages could be played to the calling party, each of the audio messages being designed to cause the calling party to terminate the setup attempt.

The playing of this type of early media by the entity operating the outbound proxy server or destination gateway likely would violate the terms of the agreement it has with the IP telephony system. However, it is impossible for the IP telephony system to know when this type of early media is being played to the calling party.

The harm caused by this type of activity can extend beyond simply a failure to establish a telephony communication between the calling and called parties. The IP telephony system may calculate certain call metrics based on all the telephony activity that it provides to its customers. One such call metric is the call completion ratio. The call completion ratio is simply the number of call setup attempts that result in a connected call, divided by the total number of call setup attempts. When the entity operating the outbound proxy server or destination gateway artificially causes the calling party to terminate a setup attempt, the IP telephony system's call completion ratio does down, which makes the IP telephony system look like it is providing poor service to its customers.

If the entity operating the outbound proxy server or destination gateway operated according to the terms of the agreement it has with the IP telephony system, and the entity cannot or chooses not to satisfy a setup request to establish a telephony communication to a called party, the entity should send a decline message back to the inbound proxy server operated by the IP telephony system. The inbound proxy server will then attempt to setup the call through an alternate outbound proxy server or destination gateway. Thus, there is still a good chance that the telephony communication will be established between the calling and called party, albeit through an alternate outbound proxy server or destination gateway operated by some other entity.

If the entity is instead playing early media to the calling party that causes the calling party to terminate the setup attempt, the IP telephony system will lose the opportunity to connect the telephony communication for the calling party, which can result in lost revenue. There is also the frustration that the calling party may experience, which is not the fault of the IP telephony system.

Moreover, if the calling party terminates a first setup attempt because the calling party heard a busy signal as early media (which was played by the entity operating the outbound proxy server or destination gateway), the calling party will likely make a second setup attempt some time later in the day. Because the IP telephony system will consult the same routing table for the second setup attempt that it consulted for the first setup attempt, the second setup attempt will likely be routed to the same outbound proxy server or destination gateway that handled the first setup attempt. And the result will probably be the same—early media consisting of a busy signal is played to the calling party. This means that the calling party may never be successful in reaching the called party, even through the IP telephony system could have routed the second call setup attempt via a different outbound proxy server or destination gateway had it known that this activity was occurring.

If the IP telephony system could determine that improper early media is being played to a calling party, the early media being designed to cause the calling party to terminate a setup attempt, the IP telephony system could take corrective action to avoid using an outbound proxy server or destination gateway that is playing improper early media.

### BRIEF DESCRIPTION OF THE DRAWINGS

FIG. 1 is a diagram of a communications environment including various elements which are associated with an Internet protocol (IP) telephony system operating in accordance with the invention;

FIG. 2 is a diagram of various elements of a processor that forms part of an IP telephony system;

FIG. 3 is a block diagram illustrating elements of a setup and monitoring system that is responsible for setting up a telephony communication between a calling and called party; and

FIG. 4 is flowchart illustrating steps of a method of setting up a telephony communication between a calling and called party.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

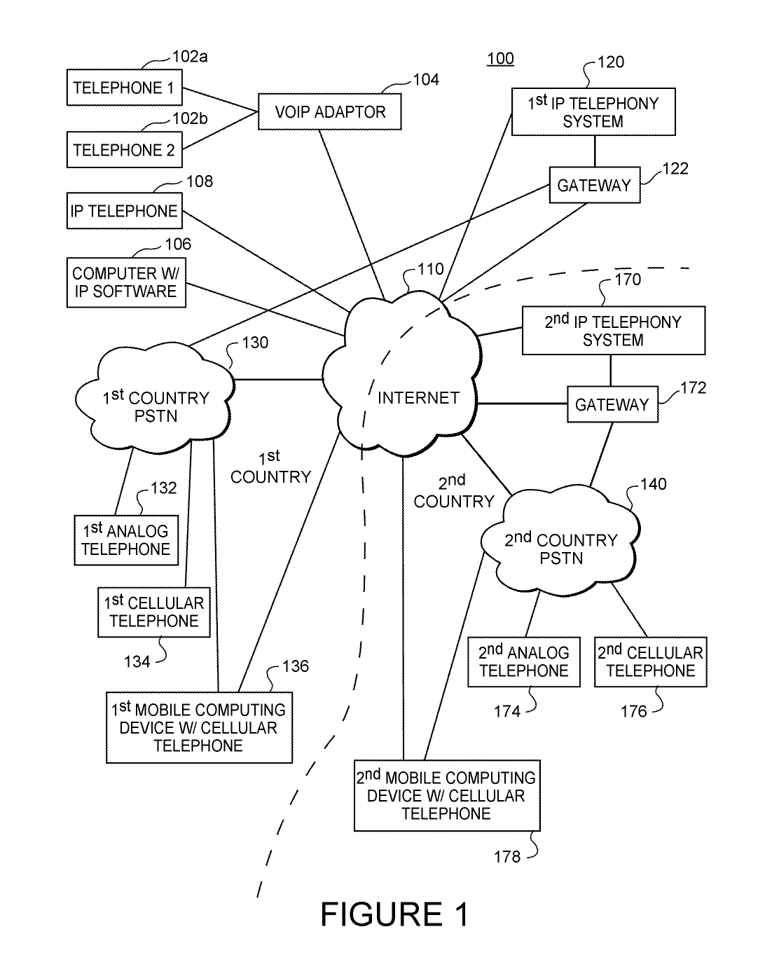

As illustrated in FIG. 1, a communications environment 100 is provided to facilitate IP based communications. A first IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to both a first publicly switched telephone network (PSTN) 130 and a second PSTN 140 via one or more gateways 122.

The gateway 122 allows users and devices that are connected to the first and second PSTNs 130, 140 to connect with users and devices that are reachable through the first IP telephony system 120, and vice versa. In some instances, the gateway 122 would be a part of the first IP telephony system 120. In other instances, the gateway 122 could be maintained by a third party.

Customers of the first IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a cellular telephone system to access the Internet 110.

Alternatively, a customer could utilize a normal analog telephone 102a which is connected to the Internet 110 via a telephone adapter 104. The telephone adapter 104 converts analog signals from the telephone 102a into data signals that pass over the Internet 110, and vice versa. Also, as illustrated in FIG. 1, multiple analog telephone devices 102a and 102b could all be coupled to the same telephone adaptor 104. Analog telephone devices include, but are not limited to, standard telephones and document imaging devices such as facsimile machines. A configuration using a telephone adapter 104 is common where all of the analog telephone devices 102a, 102b are located in a residence or business, and all of the telephone devices are connected to the same telephone adapter. With this configuration, all of the analog telephone devices 102a, 102b share the same telephone number assigned to the telephone adaptor 104. Other configurations are also possible where multiple communication lines (e.g., a second telephone number) are provisioned by the IP telephony system 120.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

A third party using the first analog telephone 132 which is connected to the first PSTN 130 may call a customer of the IP telephony system 120. In this instance, the call is initially connected from the first analog telephone 132 to the first PSTN 130, and then from the first PSTN 130, through the gateway 122 to the first IP telephony system 120. The first IP telephony system 120 then routes the call to the customer's IP telephony device. A third party using the first cellular telephone 134 could also place a call to an IP telephony system customer, and the connection would be established in a similar manner, although the first link would involve communications between the first cellular telephone 134 and a cellular telephone network. For purposes of this explanation, the cellular telephone network is considered part of the first PSTN 130.

In addition, mobile computing devices which include cellular telephone capabilities could also be used to place telephone calls to customers of the IP telephony system. The first mobile computing device 136, as illustrated in FIG. 1, might connect to the first PSTN 130 using its cellular telephone capabilities. However, such devices might also have the ability to connect wirelessly via some other means. For example, the mobile computing device 136 might communicate with a wireless data router to connect the first mobile computing device 136 directly to a data network, such as the Internet 110. In this instance, communications between the first mobile computing device 136 and other parties could be entirely carried by data communications which pass from the first mobile computing device 136 directly to a data network 110. Of course, alternate embodiments could utilize any other form of wired or wireless communications path to enable communications.

Users of the first IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the first IP telephony system 120. Further, in some instances a user could place a telephone call with the first analog telephone 132 or first cellular telephone 134 that is routed through the first PSTN 130 to the first IP telephony system 120 via the gateway 122. This would typically be accomplished by the user calling a local telephone number that is routed to the first IP telephony system 120 via the gateway 122. Once connected to the first IP telephony system 120, the user may then place an outgoing long distance call to anywhere in the world using the first IP telephony system's network. Thus, the user is able place a long distance call using lower cost IP telephony service provided by the first IP telephony system 120, rather than a higher cost service provided by the first PSTN 130.

FIG. 1 also illustrates that a second IP telephony system 170 may interact with the first IP telephony system 120 via the Internet 110. For example, customers of the second IP telephony system 170 may place calls to customers of the first IP telephony system 120. In that instance, assets of the second IP telephony system 170 interact with assets of the first IP telephony system 120 to setup and carry the telephone call. Conversely, customers of the first IP telephony system 120 can place calls to customers of the second IP telephony system 170.

The second IP telephony system 170 could also interact with customers of a second PSTN 140 via a gateway 172. The second PSTN 140 may be connected to a second analog telephone 174, a second cellular telephone 176 and a second mobile computing device 178.

In the following description, we will assume that the first IP telephony system 120, the first PSTN 130, the IP telephone 108, the VOIP adaptor 104, the first analog telephone 132, the first cellular telephone 134 and the first mobile computing device 136 are all located in a first country. Also, the second IP telephony system 170, the second PSTN 140, the second analog telephone 174, the second cellular telephone 176 and the second mobile computing device 178 are all located in a second country.

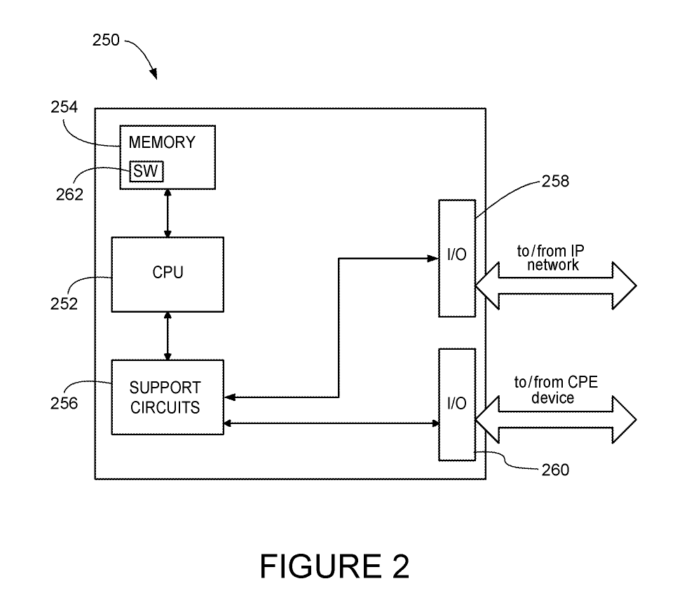

FIG. 2 illustrates elements of a computer processor 250 that can be used as part of the first or second IP telephony systems 120, 170 to accomplish various functions. Each of the IP telephony systems 120, 170 could include multiple processors 250 located at various locations in the system, along with their operating components and programming, each carrying out a specific or dedicated portion of the functions performed by the IP telephony systems 120, 170.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to complete a telephone call. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod touch can interact with an IP telephony system to conduct a telephone call.

The following description will also refer to telephony communications and telephony activity. These terms are intended to encompass all types of telephone communications, regardless of whether all or a portion of the calls are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

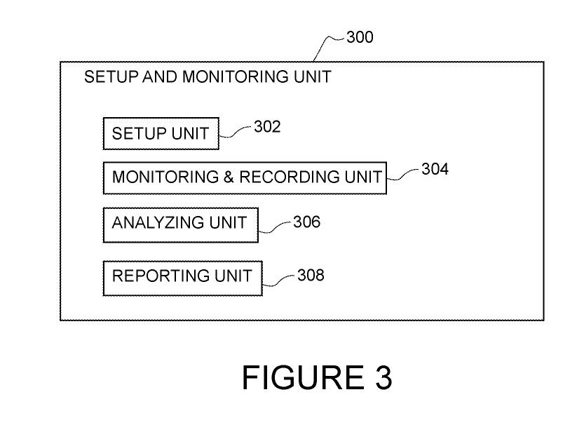

FIG. 3 illustrates a setup and monitoring unit 300 which would be part of an IP telephony system. In some embodiments, the setup and monitoring unit 300 would be part of a proxy server or gateway that receives a telephony communication setup request from a calling party, and that is responsible for setting up the telephony communication to the called party. In other embodiments, some of the elements of the setup and monitoring unit 300 shown in FIG. 3 could be part of other elements of the IP telephony system.

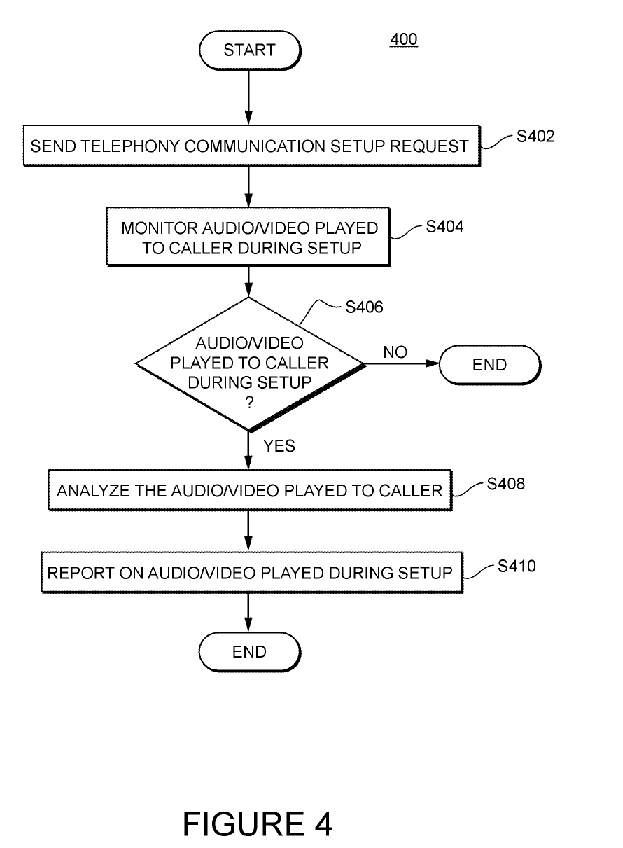

The setup and monitoring unit 300 includes a setup unit 302, a monitoring and recording unit 304, an analyzing unit 306 and a reporting unit 308. FIG. 4 illustrates steps of a method 400 that would be performed by the setup and monitoring unit 300 shown in FIG. 3. The following description refers to both FIG. 3 and FIG. 4 in explaining how the setup and monitoring unit 300 performs the method illustrated in FIG. 4.

The method 400 shown in FIG. 4 would be performed after a call setup request has been received from a calling party's telephony device. As explained above, when a call setup request is received by an inbound proxy server or originating gateway, the inbound proxy server consults a routing engine to determine the identity (e.g., IP addresses) of one or more outbound proxy servers or destination gateways that are capable of completing the requested telephony communication to the called party's telephony device.

Once the inbound proxy server has received information about the outbound proxy servers or destination gateways capable of completing the requested telephony communication, the method begins and proceeds to step S402, where the setup unit 302 sends setup signaling to a first outbound proxy server or destination gateway identified by the routing engine to request that the telephony communication be established between the calling and called parties. If the first call setup attempt is successful, the calling and called parties can begin to conduct the telephony communication. If the first call setup attempt is unsuccessful, the setup unit 302 contacts an alternate outbound proxy server or destination gateway to make a second attempt to setup the requested telephony communication. This process repeats until the telephony communication is established, or until the setup unit 302 runs out of outbound proxy servers or destination gateways to try. The method illustrated in FIG. 4 is performed during each setup attempt.

In step S404 the monitoring and recording unit 304 monitors any audio or video that is played to the calling party as the call setup attempt is ongoing. As explained above, the outbound proxy server or destination gateway may send audio or video to the calling party as early media while the call setup attempt is ongoing. In some embodiments, the monitoring and recording unit 304 will simply monitor to determine whether any audio or video is played to the calling party as early media. In other embodiments, the monitoring and recording unit will actually record any audio or video that is played to the calling party as early media.

Next, in step S406, a check is performed to determine if any audio or video was played to the calling party as early media during the call setup attempt. If not, the method ends. If so, the method proceeds to step S408, where the analyzing unit 306 analyzes the audio or video that was played to the calling party as early media. The analysis is designed to determine at least one characteristic of the audio or video.

In simple embodiments, the analysis unit 306 would determine if the audio or video corresponds to typical audio or video that would be played as early media in this context. For example, the analysis determines if the early media was a busy signal, a common ring sound, or some other type of sound that is typically played during call setup. In more complex embodiments, the analyzing unit 306 may be capable of performing speech recognition to create a transcript of any spoken messages that were played to the calling party as early media. The transcript could then be reviewed in an automated fashion, or by a system technician, to determine if the early media played to the calling party is potentially suspect.

In some embodiments, the analysis unit 306 could receive information for the calling party's telephony device to perform the analysis. In other embodiments, the analysis unit could simply directly monitor any early media that is being played to the calling party.

The analysis unit 306 may utilize digital signal processing techniques to analyze the signal spectrum of the media stream played to the calling party in order to detect the presence of early media. Early media signals often follow a repetitive pattern in the time domain which correspond to characteristic discrete spectrum. These types of spectra can be detected using digital signal processing techniques.

Next, in step S410, the reporting unit 308 reports the results of the analysis performed by the analyzing unit 308. This could include simply reporting that some form of early media was played to the calling party during call setup. This could also include reporting the full results of any analysis performed by the analysis unit 306.

The reporting unit 308 could cause information to be recorded in a call detail record (CDR) that is created for a call setup attempt. The information recorded in the CDR could simply indicate that the outbound proxy server or destination gateway played early media to the calling party. Alternatively, the information recorded in the CDR could be indicative of the type of early media that was played, or of an analysis of the early media performed by the analyzing unit 306.

The information gathered as a result of the method illustrated in FIG. 4 would be used to improve routing of new setup attempts. For example, if the setup and monitoring unit 300 determines that a particular service provider is causing its gateways to improperly play early media designed to cause the calling party to terminate a setup attempt, the routing information provided by the routing engine of the IP telephony system would be adjusted to remove the carrier from the list of available gateways capable of completing telephony communications.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of monitoring the setup of an IP telephony communication between a calling party and a called party, comprising:
sending a telephony communication setup request to an element of a communication system that can complete the telephony communication to the called party; and
analyzing media played to the calling party before the telephony communication is established between the calling and called parties to determine if the media is representative of a valid attempt to complete the telephony communication.

2. The method of claim 1, wherein analyzing media played to the calling party comprises using digital signal processing techniques to analyze the media that is played to the calling party.

3. The method of claim 2, wherein using digital signal processing techniques to analyze media played to the calling party comprises using a digital signal processing technique to identify a pattern in the time domain that corresponds to characteristic discrete spectrum.

4. The method of claim 1, wherein analyzing media played to the calling party comprises creating a transcript of a spoken message that was delivered to the calling party using speech-to-text techniques.

5. The method of claim 4, wherein analyzing media played to the calling party further comprises analyzing the transcript of the spoken message to determine if the media is representative of a valid attempt to complete the telephony communication.

6. The method of claim 1, further comprising reporting information regarding media played to the calling party based on a result of the analyzing step.

7. The method of claim 6, wherein the reporting step comprises causing information to be added to a call detail record that is created for the telephony communication setup request.

8. The method of claim 7, wherein the information added to the call detail record provides an indication that media was played to the calling party before the telephony communication was established between the calling and called parties, the added information also providing an indication of at least one characteristic of the media.

9. The method of claim 1, wherein the analyzing step comprises receiving information from an IP telephony device that is used by the calling party.

10. The method of claim 1, further comprising recording any media that is played to the calling party before the telephony communication is established between the calling and called parties.

11. A system for monitoring the setup of an IP telephony communication between a calling party and a called party, comprising:
means for sending a telephony communication setup request to an element of a communication system that can complete the telephony communication to the called party; and
means for analyzing media played to the calling party before the telephony communication is established between the calling and called parties to determine if the media is representative of a valid attempt to complete the telephony communication.

12. A system for monitoring the setup of an IP telephony communication between a calling party and a called party, comprising:
a setup unit that sends a telephony communication setup request to an element of a communication system that can complete the telephony communication to the called party; and
an analyzing unit that analyzes media played to the calling party before the telephony communication is established between the calling and called parties to determine if the media is representative of a valid attempt to complete the telephony communication.

13. The system of claim 11, wherein the analyzing unit uses a digital signal processing techniques to analyze the media played to the calling party.

14. The system of claim 13, wherein the analyzing unit uses a digital signal processing technique to identify a pattern in the time domain that corresponds to characteristic discrete spectrum.

15. The system of claim 12, wherein the analyzing unit creates a transcript of a spoken message that was delivered to the calling party using speech-to-text techniques.

16. The system of claim 15, wherein the analyzing unit analyzes the transcript of the spoken message to determine if the media is representative of a valid attempt to complete the telephony communication.

17. The system of claim 12, further comprising a reporting unit that reports information regarding media played to the calling party using input from the analyzing unit.

18. The system of claim 17, wherein the reporting unit causes information to be added to a call detail record that is created for the telephony communication setup request.

19. The system of claim 18, wherein the reporting unit adds information to the call detail record that also provides an indication of at least one characteristic of the media.

20. The system of claim 12, wherein the analyzing unit receives information from an IP telephony device that is used by the calling party.

21. The system of claim 12, further comprising a recording and monitoring unit that records media played to the calling party before the telephony communication is established between the calling and called parties.
